(19) United States
(12) Patent Application Publication
(10) Pub. No.: US 2015/0088973 A1
(43) Pub. Date: Mar. 26, 2015

(54) Network Management System, Network Path Control Module, And Network Management Method Thereof

(71) Applicant: Wistron Corporation, New Taipei City (TW)

(72) Inventor: CHIH-MING CHEN, New Taipei City (TW)

(21) Appl. No.: 14/315,916

(22) Filed: Jun. 26, 2014

(30) Foreign Application Priority Data
Sep. 26, 2013 (TW) 102134684

(51) Int. Cl. H04L 12/717; H04L 29/06

(52) U.S. Cl. CPC H04L 45/42; H04L 67/42
USPC 709/203

(57) ABSTRACT

A network management system, a network path control module, and a network management method thereof are disclosed; wherein the network management system is used for transmitting a data between a client and a plurality of servers. The network management system includes the network path control module and a plurality of transmission modules. The network path control module electrically connects to the client. The plurality of transmission modules electrically connect to the network path control module for electrically connecting the data between the client and the plurality of servers, wherein the plurality of transmission modules electrically connect to each other. When the data is transmitted, the network path control module chooses an appointed transmission module from the plurality of transmission modules so as to form a data transmission path between the client and the plurality of servers via the appointed transmission module.

### BACKGROUND OF THE INVENTION

1. Field of the Invention

The present invention relates to a network management system and a network management method thereof; more particularly, the present invention relates to a network management system and a network management method thereof capable of adjusting a data transmission path.

2. Description of the Related Art

With the progress of technology development, internet surfing has become an inevitable activity for each modern people; therefore, network environment applications in modern lives have become very common. In order to increase the network bandwidth, additional server equipment and a plurality of routers are usually installed to meet client demands in known prior arts, so as to directly process the transmission of network signals via the routers. When the client has a data transmission request, different routers would communicate with each other to directly allocate and transmit data. Therefore, the router in known prior arts has very powerful functions; however, it also leads to the increase in the manufacturing cost. As a result, because the cost of the router is expensive, the cost burden of a network company would be increased by installing additional routers, which is unaffordable for the network company, and thereby resulting in the limitation to the network development.

Therefore, there is a need to provide a network management system and a network management method thereof to mitigate and/or obviate the aforementioned problems.

### SUMMARY OF THE INVENTION

It is an object of the present invention to provide a network management system, which is capable of adjusting data transmission path efficiency.

It is another object of the present invention to provide a network management method used in the above network management system.

It is yet another object of the present invention to provide a network path control module used in the above network management system.

To achieve the abovementioned objects, the network management system of the present invention is used for transmitting a data between a client and a plurality of servers. The network management system comprises a network path control module and a plurality of transmission modules. The network path control module is electrically connected to the client. The plurality of transmission modules are electrically connected to the network path control module, and are used for electrically connecting between the client and the plurality of servers. The plurality of transmission modules are electrically connected to each other. When the data is transmitted, the network path control module chooses an appointed transmission module from the plurality of transmission modules, so as to form a data transmission path between the client and the plurality of servers via the appointed transmission module.

The network management method of the present invention comprises the following steps: executing a data input procedure, including: transmitting an input data; choosing an appointed transmission module from a plurality of transmission modules; and transmitting the input data to one of the servers directly via the appointed transmission module; and executing a data output procedure, including: transmitting an output data; choosing the appointed transmission module from the plurality of transmission modules; and transmitting the output data to the client directly via the appointed transmission module.

The network path control module of the present invention is used in a network management system, and is used for connecting to a client, a plurality of transmission modules, and a plurality of servers, such that a data can be transmitted between the client and the plurality of servers. The plurality of transmission modules are electrically connected to each other. The network path control module comprises a processor and a memory. The memory is electrically connected to the processor, and is used for storing a computer program. When the data needs to be transmitted, the processor chooses an appointed transmission module from the plurality of transmission modules via the computer program, so as to form a data transmission path between the client and the plurality of servers.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A illustrates a structural schematic drawing of a network management system of the present invention.

FIG. 1B illustrates a schematic drawing showing connections of the network management system to a client and a plurality servers of the present invention.

FIG. 2 illustrates a structural schematic drawing of the network management system according to a first embodiment of the present invention.

FIG. 3 illustrates a structural schematic drawing of the network management system according to a second embodiment of the present invention.

FIG. 4 illustrates a structural schematic drawing of the network management system according to a third embodiment of the present invention.

FIG. 5 illustrates a structural schematic drawing of the network management system according to a fourth embodiment of the present invention.

FIG. 6 illustrates a structural schematic drawing of the network management system according to a fifth embodiment of the present invention.

FIG. 7 illustrates a flowchart of a network management method executing a data input procedure according to the present invention.

FIG. 8 illustrates a flowchart of the network management method executing a data output procedure according to the present invention.

### DETAILED DESCRIPTION OF THE PREFERRED EMBODIMENT

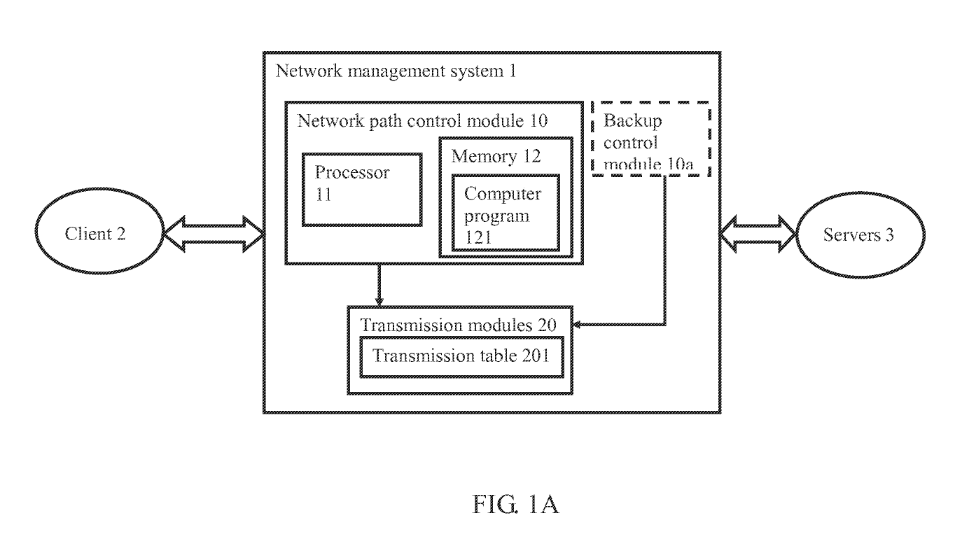

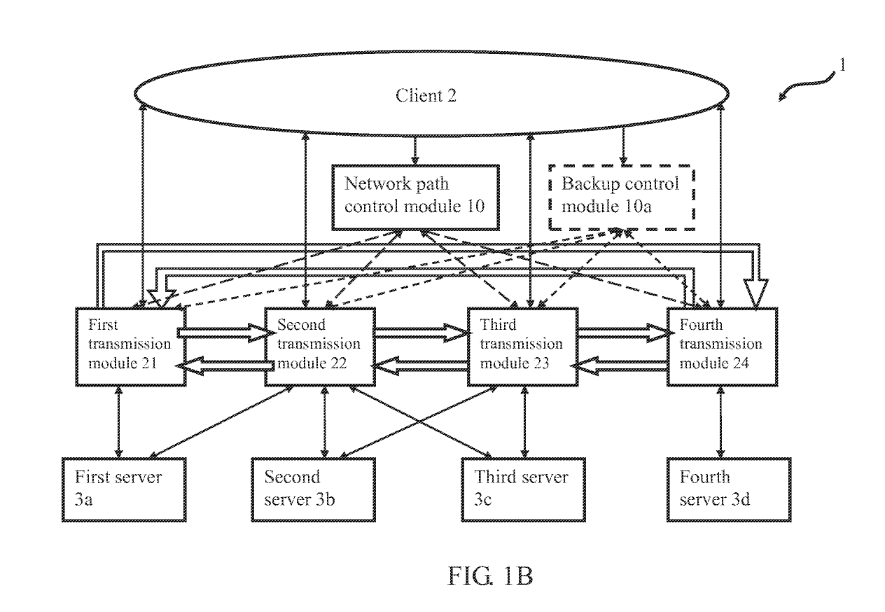

Please refer to FIG. 1A and FIG. 1B regarding related schematic drawings of a network management system, wherein FIG. 1A illustrates a structural schematic drawing of a network management system of the present invention, and FIG. 1B illustrates a schematic drawing showing connections of the network management system to a client and a plurality servers of the present invention.

The network management system 1 of the present invention is installed between a client 2 and a plurality of servers 3, so as to form a data transmission path between the client 2 and the plurality of servers 3. The network management system 1 comprises a network path control module 10, a backup control module 10a, and a plurality of transmission modules 20. The network path control module 10 is electrically connected to the client 2, and is connected to the plurality of transmission modules 20, so as to control whether each transmission module is connected to the client 2 or the plurality of servers 3. The network path control module 10 can comprise a processor 11 and a memory 12 with each other electrically connected. The memory 12 is stored with a computer program 121. Therefore, the processor 11 can utilize the computer program 121 to execute all kinds of necessary procedures. The plurality of transmission modules 20 are electrically connected to the client 2, and are connected to partial or all of the servers 3. According to a first transmission module 21 to a fourth transmission module 24 as shown in FIG. 1B, the first transmission module 21 is connected to a first server 3a; the second transmission module 22 is connected to the first server 3a, a second server 3b and a third server 3c; the third transmission module 23 is connected to the second server 3b and the third server 3c; and finally the fourth transmission module 24 is connected to a fourth server 3d. The transmission module 20 can be a well-known switch or router, which can be operated completely by the network path control module 10.

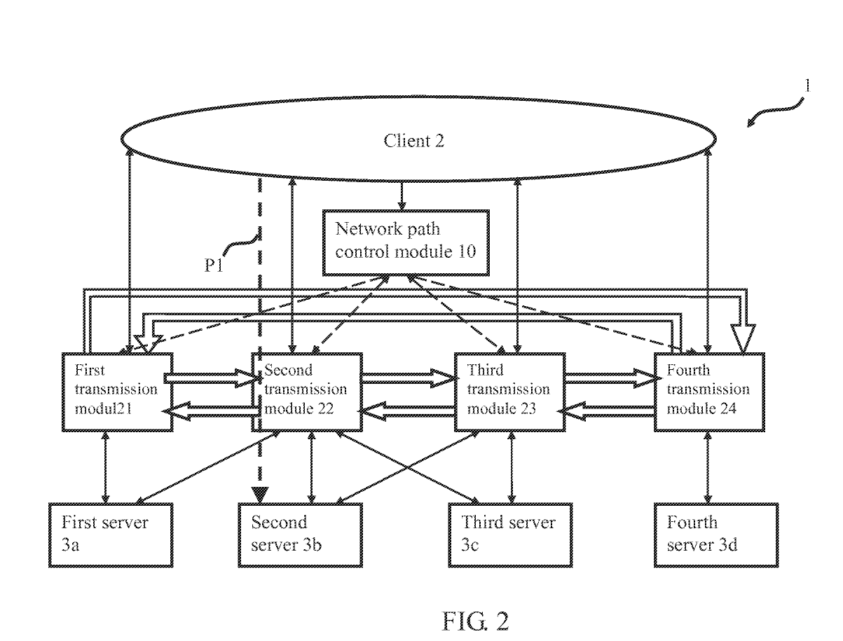

When the data needs to be transmitted, the processor 11 of the network path control module 10 chooses an appointed transmission module from the plurality of transmission modules 20, so as to form the data transmission path between the client 2 and the plurality of servers 3. The plurality of transmission modules 20 are electrically connected to each other. Therefore, when one of the transmission modules has higher loading or is broken down, the processor 11 would choose another transmission module which has lower loading or is idle for transmitting signals, so as to form the data transmission path between the client 2 and the plurality of servers 3, such as the data transmission paths P1 to P5 as shown from FIG. 2 to FIG. 6; however, please note that the scope of the present invention is not limited to the embodiments illustrated from FIG. 2 to FIG. 6.

The plurality of transmission modules 20 can have a plurality of transmission tables 201, such as MAC tables or routing tables. The processor 11 of the network path control module 10 controls the plurality transmission modules 20 for changing the plurality of transmission tables 201 in order to form the data transmission path. In another aspect, the processor 11 of the network path control module 10 can also control the plurality of transmission modules 20 via a multi-protocol label switching protocol in order to form the data transmission path. However please note that the scope of the present invention is not limited to the above description. Because the principle of the above mentioned multi-protocol label switching protocol is well known to one of ordinary skill in the art, and is not the major improvement related to the present invention, there is no need for further description.

Moreover, the network management system 1 can further comprise the backup control module 10a. The backup control module 10a has the same function as the network path control module 10 does, and is also electrically connected to the client 2 and the plurality of transmission modules 20. The backup control module 10a can be used for supporting the network path control module 10, and can substitute the network path control module 10 when the network path control module 10 is broken down.

Please note that each of the above modules not only can be configured as a hardware device, a software program, firmware or a combination thereof, but also can be configured as a circuit loop or any other appropriate formation. Further, each module can be in either an independent-type configuration or a combined-type configuration. In a preferred embodiment, each module is a software program stored in the memory, and the function of the present invention can be achieved by utilizing the processor to execute each module. Moreover, each of the above modules can be electrically connected to each other via a wired connection (such as an optical fiber or a cable) or a wireless connection (such as Wifi or 3G) so as to establish a network. Furthermore, the embodiment section only describes preferred embodiments of the present invention, all possible variations and combinations are not described in detail in order to avoid redundant description. However, one of ordinary skill in the art should be aware that not all of the above mentioned modules or components are essential; also, in order to implement the present invention, other more detailed known modules or components may be utilized. Each module or component can be skipped or modified according to different requirements, and other modules or components might possibly exist between every two modules.

As for the embodiments that the network path control module 10 controls the plurality of transmission modules 20, please refer to FIG. 2 to FIG. 6 for more details. Please note that the embodiments illustrated from FIG. 2 to FIG. 6 are only for exemplary purposes without limiting the scope of the present invention. Further, because the backup control module 10a acts similarly as the network path control module 10 does, the following FIG. 2 to FIG. 6 skip the description corresponding to the backup control module 10a. Firstly, please refer to FIG. 2, which illustrates a structural schematic drawing of the network management system according to a first embodiment of the present invention.

When the client 2 needs to transmit an input data to the plurality of servers 3, the input data would has a first package signal. The network path control module 10 firstly receives the first package signal, so as to choose the appointed transmission module from the plurality of transmission modules 20 according to the first package signal, and therefore to transmit the input data to one of the servers directly via the appointed transmission module. For example, if the client 2 needs to transmit the input data to the second server 3b, the processor 11 of the network path control module 10 firstly knows that the input data needs to be transmitted to the second server 3b according to the first package signal. Therefore, according to the computer program 121, the processor 11 chooses the second transmission module 22 directly connected to the second server 3b as the appointed transmission module, so as to control the second transmission module 22 to directly connect to the client 2 for receiving the input data, and then to transmit the input data to the second server 3b. As a result, the network path control module 10 can form a data transmission path P1 for transmitting data.

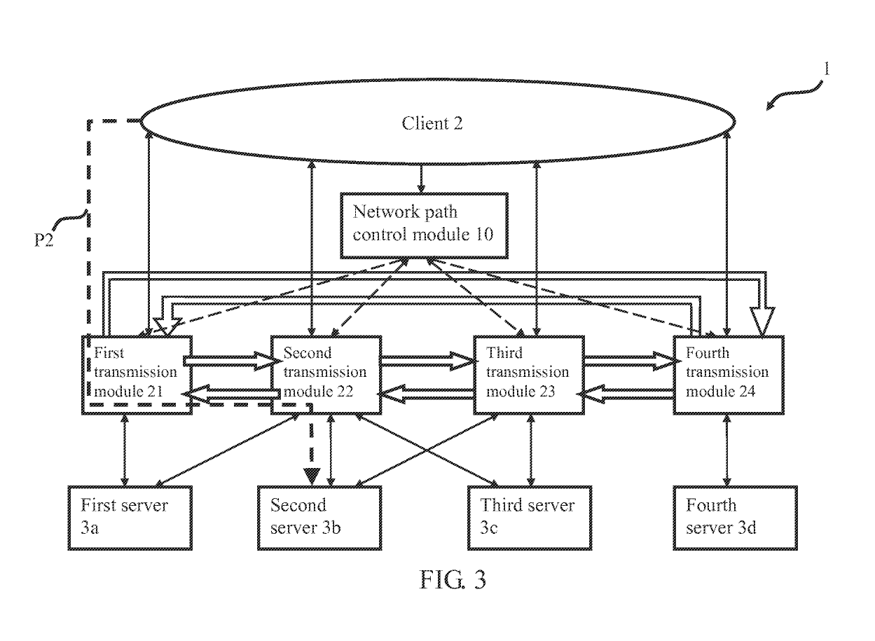

Then, please refer to FIG. 3, which illustrates a structural schematic drawing of the network management system according to a second embodiment of the present invention.

Besides choosing the appointed transmission module according to a physical linking status of the plurality of transmission modules 20, the processor 11 of the network path control module 10 can also choose the appointed transmission module according to a flow of respective loading of the plurality of transmission modules 20. For example, if the client 2 needs to transmit the input data to the second server 3b, but the second server 3b has too much loading; then according to the computer program 121, the processor 11 would firstly transmit the input data of the client 2 to the first transmission module 21 having relatively low loading, then transmit to the second transmission module 22, and finally transmit to the second server 3b. As a result, the network path control module 10 can form another data transmission path P2, such that the input data of the client 2 can still be successfully transmitted to the second server 3b.

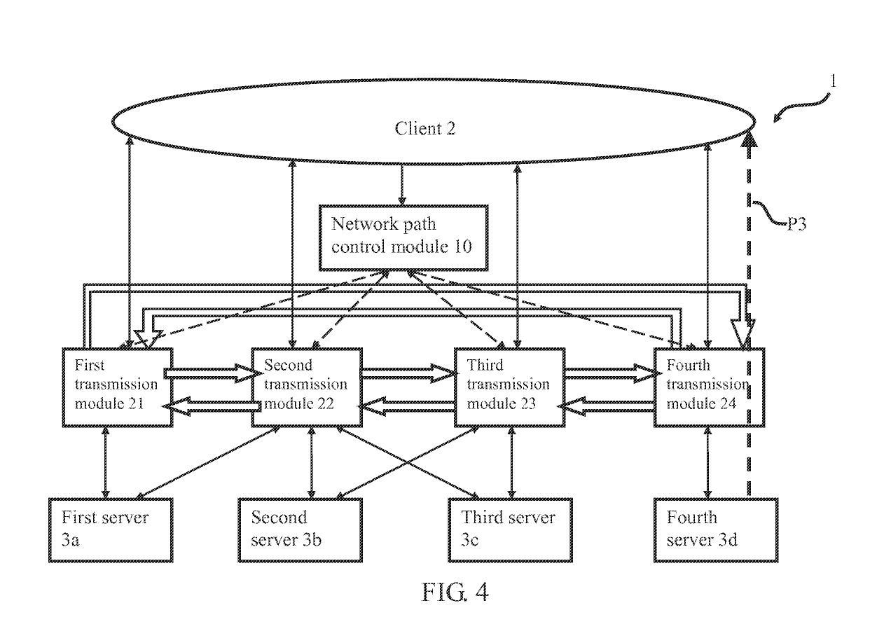

Next, please refer to FIG. 4, which illustrates a structural schematic drawing of the network management system according to a third embodiment of the present invention.

When the plurality of servers 3 transmits an output data, the processor 11 of the network path control module 10 chooses the appointed transmission module from the plurality of transmission modules 20 according to the computer program 121, so as to transmit the output data to the client 2 directly via the appointed transmission module. For example, if the fourth server 3d needs to transmit the output data to the client 2, the output data of the fourth server 3d would be directly transmitted to its connected fourth transmission module 24, and at this time the network path control module 10 chooses the fourth transmission module 24 as the appointed transmission module, and therefore forms a data transmission path P3 for transmitting the output data.

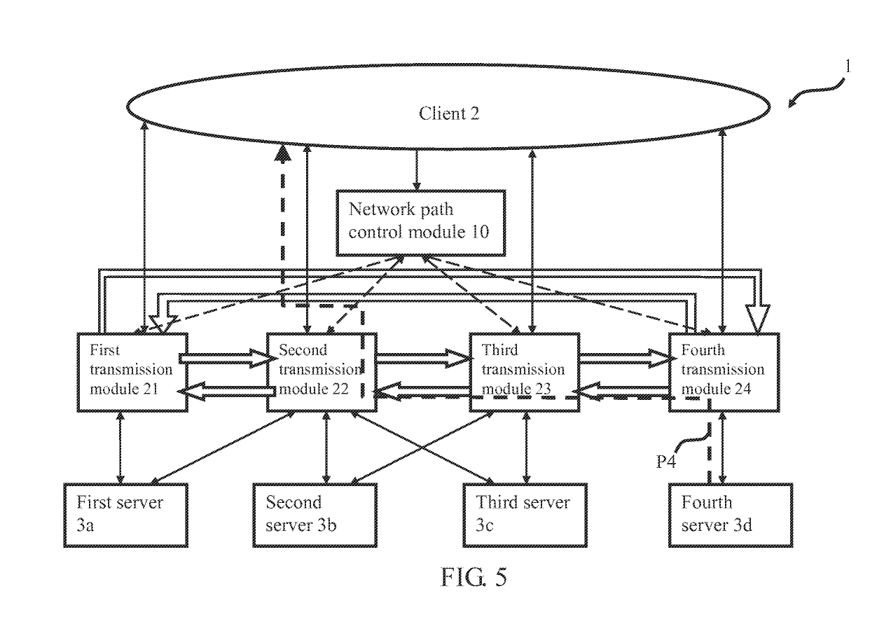

Then, please refer to FIG. 5, which illustrates a structural schematic drawing of the network management system according to a fourth embodiment of the present invention.

Similarly, the processor 11 of the network path control module 10 would choose the appointed transmission module according to a flow of respective loading of the plurality of transmission modules 20. If the fourth server 3d needs to transmit the output data, but the fourth transmission module 24 has higher loading whereas the second transmission module 22 has lower loading; then according to the computer program 121, the processor 11 of the network path control module 10 would control the output data to be transmitted to the second transmission module 22 directly via the fourth transmission module 24 and the third transmission module 23, and finally to be output to the client 2 via the second transmission module 22. Therefore, the network path control module 10 forms a new data transmission path P4 to substitute the original data transmission path P3.

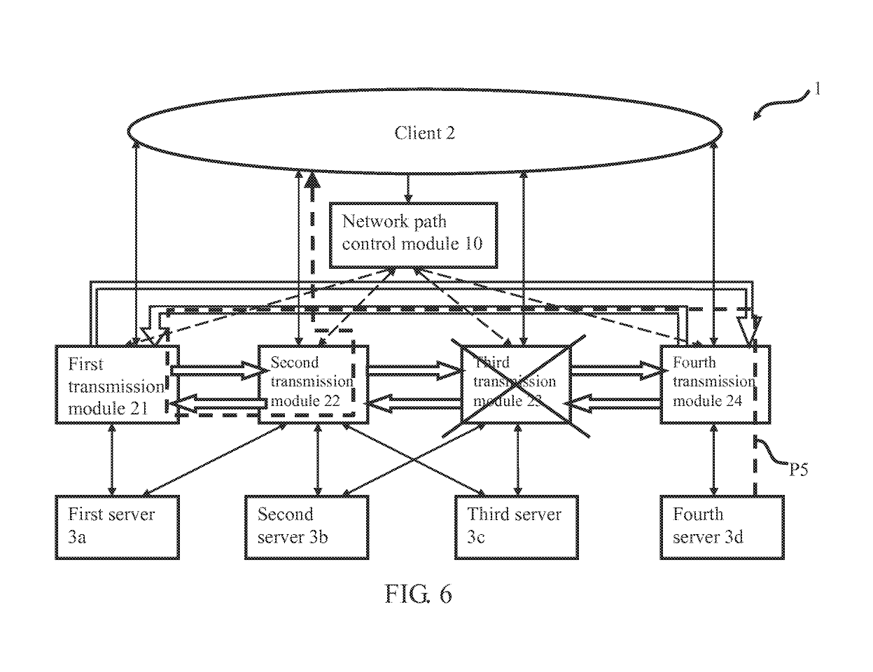

Next, please refer to FIG. 6, which illustrates structural schematic drawing of the network management system according to a fifth embodiment of the present invention.

Further, if one transmission module of the plurality of transmission modules 20 is broken down, the processor 11 of the network path control module 10 would further choose another appointed transmission module, so as to reform the data transmission path. For example, if the third transmission module 23 is broken down and unable to transmit data, the fourth transmission module 24 would not be able to transmit data from the third transmission module 23 to the second transmission module 22. At this time, the processor 11 of the network path control module 10 would, via the computer program 121, choose the fourth transmission module 24 to pass through the first transmission module 21 in order to transmit to the second transmission module 22, and finally output the data from the second transmission module 22 to the client 2. As a result, the network path control module 10 can form a different data transmission path P5.

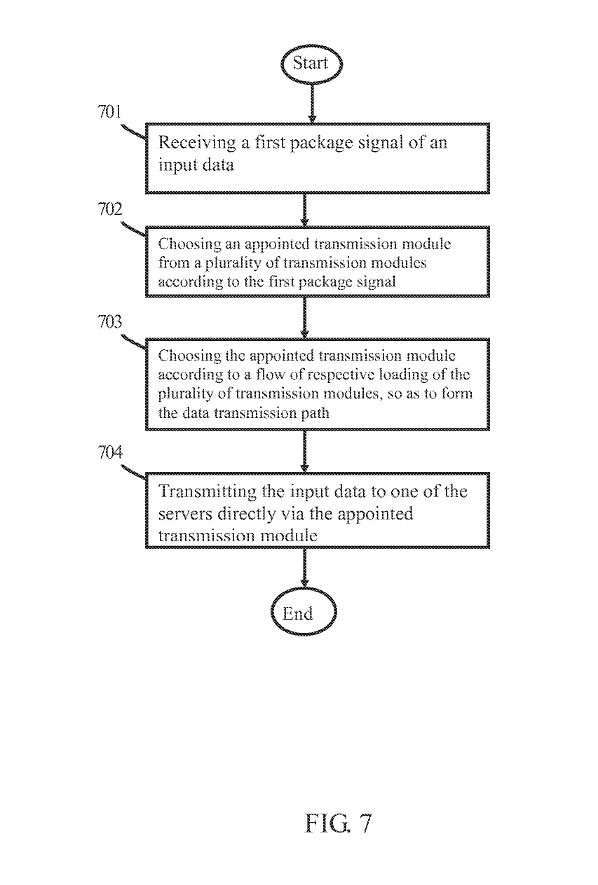

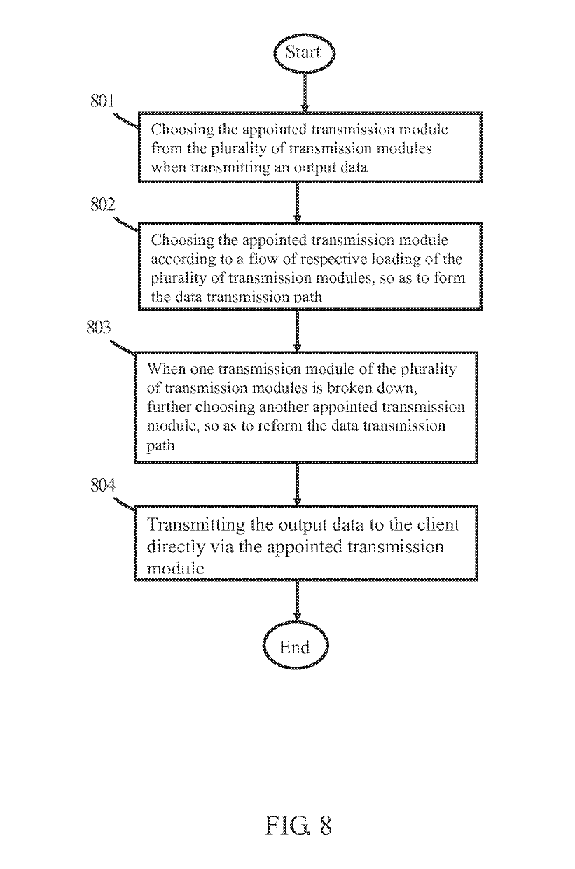

Then, please refer to FIG. 7 and FIG. 8 regarding flowcharts of a network management method according to the present invention, wherein FIG. 7 illustrates a flowchart of the network management method executing a data input procedure according to the present invention, and FIG. 8 illustrates a flowchart of the network management method executing a data output procedure according to the present invention. Please note that in the following embodiment, although the network management system 1 having the network path control module 10 is used as an example to explain the network management method of the present invention, the scope of the network management method of the present invention is not limited to be used in the network path control module 10.

Firstly, the method performs step 701: receiving a first package signal of an input data.

When the client 2 needs to transmit a data to the plurality of servers 3, the processor 11 of the network path control module 10 firstly knows to which server of the plurality of servers 3 the input data needs to be transmitted according to the first package signal of the input data.

Then, the method performs step 702: choosing an appointed transmission module from the plurality of transmission modules according to the first package signal.

Then, according to content in the first package signal, the processor 11 of the network path control module 10 knows to which server the data needs to be transmitted. Therefore, according to physical linking paths among the plurality of transmission modules 20 and the plurality of servers 3, the network path control module 10 chooses the appointed transmission module from the plurality of transmission modules 20. As shown in FIG. 2, the processor 11 of the network path control module 10 chooses the second transmission module 22 as the appointed transmission module via the computer program 121.

Meanwhile, the method performs step 703: choosing the appointed transmission module according to a flow of respective loading of the plurality of transmission modules, so as to form the data transmission path.

Besides choosing the appointed transmission module according to the physical linking paths, the processor 11 of the network path control module 10 can also choose the appointed transmission module according to a flow of respective loading of the plurality of transmission modules 20. As shown in FIG. 3, if the second transmission module 22 has too much loading, the processor 11 of the network path control module 10 would, via the computer program 121, appoint the first transmission module 21 having relatively low loading to connect to the client 2. If one transmission module is broken down, the processor 11 of the network path control module 10 can also re-adjust the data transmission path.

Finally, the method performs step 704: transmitting the input data to one of the servers directly via the appointed transmission module.

Finally, after being through the above steps 702 and 703, the network path control module 10 can establish the data transmission path between the client 2 and the plurality of servers 3, so as to successfully transmit the input data to the plurality of servers.

Moreover, if the plurality of servers 3 needs to transmit an output data, the method firstly performs step 801: choosing the appointed transmission module from the plurality of transmission modules when transmitting an output data.

When the plurality of servers 3 transmits the output data, the processor 11 of the network path control module 10 chooses the appointed transmission module from the plurality of transmission modules 20. As shown in FIG. 4, if the fourth server 3d needs to transmit the output data to the client 2, the processor 11 of the network path control module 10 would, via the computer program 121, directly choose the fourth transmission module 24 connected to the fourth server 3d as the appointed transmission module.

Then, the method performs step 802: choosing the appointed transmission module according to a flow of respective loading of the plurality of transmission modules, so as to form the data transmission path.

Similar to step 703, the processor 11 of the network path control module 10 would choose the appointed transmission module according to a flow of respective loading of the plurality of transmission modules 20. As shown in FIG. 5, if the fourth transmission module 24 has higher loading, the network path control module 10 would directly choose the second transmission module 22 having lower loading as the appointed transmission module.

Meanwhile, the method performs step 803: when one transmission module of the plurality of transmission modules is broken down, further choosing another appointed transmission module, so as to reform the data transmission path.

Further, if one transmission module of the plurality of transmission modules 20 is broken down, the processor 11 of the network path control module 10 would further choose another appointed transmission module, so as to reform the data transmission path. As shown in FIG. 6, if the third transmission module 23 is broken down, the processor 11 of the network path control module 10 would avoid the third transmission module 23, and instead appoint the first transmission module 21 to transmit the output data to the second transmission module 22, so as to form a different data transmission path P5.

Finally, the method performs step 804: transmitting the output data to the client directly via the appointed transmission module.

Finally, after being through the above steps 801 to 803, the network path control module 10 can choose the appointed transmission module, so as to transmit the output data to the client 2.

Please note that the network management method of the present invention is not limited to the above mentioned step orders. It is understood that the order of execution may differ from that which is depicted as long as the object of the present invention can be achieved.

According to the network management system 1 and the network management method of the present invention, the objects of outputting and inputting data can be achieved by means of utilizing a network path control module 10 associated with a plurality of transmission modules 20. Further, the plurality of transmission modules 20 are only used for a simple function of transmitting data, and therefore can effectively reduce the maintenance fee or cost of increasing the plurality of transmission modules 20.

Although the present invention has been explained in relation to its preferred embodiments, it is to be understood that many other possible modifications and variations can be made without departing from the spirit and scope of the invention as hereinafter claimed.

What is claimed is:

1. A network management system, used for transmitting a data between a client and a plurality of servers, the network management system comprising:
a network path control module, electrically connected to the client; and
a plurality of transmission modules, electrically connected to the network path control module, and used for electrically connecting between the client and the plurality of servers; wherein the plurality of transmission modules are electrically connected to each other; and when the data being transmitted, the network path control module choosing an appointed transmission module from the plurality of transmission modules, so as to form a data transmission path between the client and the plurality of servers via the appointed transmission module.

2. The network management system as claimed in claim 1, wherein when an input data is transmitted from the client, the network path control module chooses the appointed transmission module via a computer program, so as to transmit the input data to one of the servers via the appointed transmission module.

3. The network management system as claimed in claim 2, wherein the input data has a first package signal, and the network path control module receives the first package signal, so as to choose the appointed transmission module according to the first package signal.

4. The network management system as claimed in claim 1, wherein when an output data is transmitted from the plurality of servers, the network path control module chooses the appointed transmission module via a computer program, so as to transmit the output data to the client via the appointed transmission module.

5. The network management system as claimed in claim 1, wherein the network path control module further chooses the appointed transmission module according to a flow of respective loading of the plurality of transmission modules, so as to form the data transmission path.

6. The network management system as claimed in claim 1, wherein when one transmission module of the plurality of transmission modules is broken down, the network path control module further chooses another appointed transmission module, so as to reform the data transmission path.

7. The network management system as claimed in claim 1, wherein the plurality of transmission modules have a plurality of transmission tables, and the network path control module changes the plurality of transmission tables to control the plurality of transmission modules, so as to form the data transmission path.

8. The network management system as claimed in claim 1, wherein the network path control module controls the plurality of transmission modules via a multi-protocol label switching protocol, so as to form the data transmission path.

9. The network management system as claimed in claim 1, further comprising a backup control module used for supporting the network path control module.

10. A network management method, used in a network management system for transmitting data between a client and a plurality of servers, the method comprising the following steps:
executing a data input procedure, comprising:
transmitting input data;
choosing an appointed transmission module from the plurality of transmission modules; and
transmitting the input data to one of the servers directly via the appointed transmission module;
and
executing a data output procedure, comprising:
transmitting output data;
choosing the appointed transmission module from the plurality of transmission modules; and
transmitting the output data to the client directly via the appointed transmission module.

11. The network management method as claimed in claim 10, wherein the step of executing the data input procedure further comprises:
receiving a first package signal, so as to choose the appointed transmission module according to the first package signal.

12. The network management method as claimed in claim 10, further comprising the following step:
choosing the appointed transmission module according to a flow of respective loading of the plurality of transmission modules.

13. The network management method as claimed in claim 10, further comprising the following step:
when one transmission module of the plurality of transmission modules is broken down, further choosing another appointed transmission module.

14. A network path control module, used in a network management system, used for connecting to a client, a plurality of transmission modules, and a plurality of servers, such that a data can be transmitted between the client and the plurality of servers; wherein the plurality of transmission modules are electrically connected to each other; the network path control module comprising:
a processor; and
a memory, electrically connected to the processor, used for storing a computer program; wherein when data needs to be transmitted, the processor chooses an appointed transmission module from the plurality of transmission modules via the computer program, so as to form a data transmission path between the client and the plurality of servers.

15. The network path control module as claimed in claim 14, wherein:
when the client transmits an input data, the processor chooses the appointed transmission module via the computer program, so as to transmit the input data to one of the servers directly via the appointed transmission module; and
when the plurality of servers transmit an output data, the processor chooses the appointed transmission module via the computer program, so as to transmit the output data to the client directly via the appointed transmission module.

16. The network path control module as claimed in claim 15, wherein the input data has a first package signal, and the network path control module receives the first package signal, so as to choose the appointed transmission module according to the first package signal.

17. The network path control module as claimed in claim 14, wherein the processor further chooses the appointed transmission module according to a flow of respective loading of the plurality of transmission modules, so as to form the data transmission path.

18. The network path control module as claimed in claim 14, wherein when one transmission module of the plurality of transmission modules is broken down, the processor further chooses another appointed transmission module via the computer program, so as to reform the data transmission path.

19. The network path control module as claimed in claim 14, wherein the plurality of transmission modules have a plurality of transmission tables, and the processor changes the plurality of transmission tables via the computer program to control the plurality of transmission modules, so as to form the data transmission path.

20. The network path control module as claimed in claim 14, wherein the processor controls the plurality of transmission modules via a multi-protocol label switching protocol, so as to form the data transmission path.
